(19) United States
(12) Patent Application Publication
(10) Pub. No.: US 2010/0274770 A1
(43) Pub. Date: Oct. 28, 2010

(54) TRANSDUCTIVE APPROACH TO CATEGORY-SPECIFIC RECORD ATTRIBUTE EXTRACTION

(75) Inventors: Rahul Gupta, Mumbai (IN); Sathiya Keerthi Selvaraj, Cupertino, CA (US); Daniel Kifer, State College, PA (US); Srujana Merugu, Sunnyvale, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/429,442

(22) Filed: Apr. 24, 2009

(51) Int. Cl. G06F 17/30

(52) U.S. Cl. 707/688; 707/E17.131

(57) ABSTRACT

Disclosed are methods and apparatus for segmenting and labeling a collection of token sequences. A plurality of segments of one or more tokens in a token sequence collection are partially labeled with labels from a set of target labels using high precision domain-specific labelers so as to generate a partially labeled sequence collection having a plurality of labeled segments and a plurality of unlabeled segments. Any label conflicts in the partially labeled sequence collection are resolved. One or more of the labeled segments of the partially labeled sequence collection are expanded so as to cover one or more additional tokens of the partially labeled sequence collection. A statistical model, for labeling segments using local token and segment features of the sequence collection, is trained based on the partially labeled sequence collection. This trained model is then used to label the unlabeled segments and the labeled segments of the sequence collection so as to generate a labeled sequence collection. The labeled sequence collection is then stored as structured output records in a database.

### BACKGROUND OF THE INVENTION

The present invention is related to techniques and mechanisms for extracting information from web pages and other such types of documents.

Over the last decade, the web has transformed into a massive repository of unstructured and semi-structured information, as well as a gateway into numerous databases. A significant portion of this information occurs in the form of sets of various types of entity-records (henceforth, referred to as records) on HTML (hyper text markup language) web pages, where each entity record refers to a set of attributes associated with an entity. For example, a store record may be composed of attributes such as name, address and phone number of a business store. These records correspond to web page fragments that are similarly positioned with respect to the HTML DOM structure of a webpage or site and HTML structure of a website. An important special case is one where the records are arranged contiguously on a web page to form a list of records. Examples include pages containing lists of store locator results, shopping product details, or events from a calendar.

An intelligent mechanism for converting such diverse information into a structured and usable form would be beneficial.

### SUMMARY OF THE INVENTION

In certain embodiments, a method of segmenting and labeling a collection of token sequences is disclosed. A plurality of segments of one or more tokens in a token sequence collection are partially labeled with labels from a set of target labels using high precision domain-specific labelers so as to generate a partially labeled sequence collection having a plurality of labeled segments and a plurality of unlabeled segments. For instance, one or more web page fragments are represented as sequences of text or HTML (HyperText Markup Language) tokens (e.g., words), and then some segments of such token sequences are labeled while other segments are left unlabeled. Any label conflicts in the partially labeled sequence collection are resolved. One or more of the labeled segments of the partially labeled sequence collection are expanded so as to cover one or more additional tokens of the partially labeled sequence collection. A statistical model, for labeling segments using local token and segment features of the sequence collection, is trained based on the partially labeled sequence collection. This trained model is then used to label the unlabeled segments and the labeled segments (e.g., relabeling) of the sequence collection so as to generate a labeled sequence collection. The labeled sequence collection is then stored as structured output records in a database.

In a specific implementation, the sequence collection includes entity records formed by similar fragments in a single web page or web site. The labeled segments correspond to record attributes, and the tokens are obtained by tokenizing a source HTML or text in the fragments. In a further aspect, the local token and segment features are chosen to be web site-specific or web page-specific properties, such as features based on XPath, punctuation patterns, visual placement, etc. In another embodiment, the domain-specific labelers are improved using the labeled sequence collection. In yet another embodiment, the operation of resolving any label conflicts is accomplished by (i) for a given set of labeled segments from the partially labeled sequence collection, choosing a non-overlapping subset of these labeled segments such that a maximum number of tokens are labeled while ensuring that a set of user specified constraints are not violated, and (ii) retaining the chosen non-overlapping subset of labeled segments while removing labels of the other labeled segments that are not part of the chosen non-overlapping subset.

In another aspect, expansion of the labeled segments is accomplished using user-specified boundary properties for various labels. In yet another embodiment, the statistical model is a joint sequential model that labels all tokens in a sequence together, rather than independently. In another implementation, training the statistical model is based on optimizing a marginal likelihood over the partially labeled sequence collection, and inference of segmentation and labeling of token sequences is based on the learned statistical model and a set of user-specified constraints.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a procedure for adaptively extracting information from a web page in accordance with a specific implementation of the present invention.

FIG. 3 is an example representation of a partially labeled sequence collection.

FIG. 4A illustrates the record of FIG. 3 after conflict resolution has been performed in accordance with a specific example.

FIG. 4B illustrates the record of FIG. 4A after label expansion in accordance with one embodiment of the present invention.

FIG. 5 is a flowchart illustrating a conflict resolution procedure in accordance with a specific implementation of the present invention.

FIG. 6 is a flowchart illustrating a label expansion procedure in accordance with one embodiment of the present invention.

FIG. 7 shows four vectors that can be used in a training approach in accordance with a specific implementation of the present invention.

FIG. 8 shows an algorithm that can be used in a training approach in accordance with a specific implementation of the present invention.

FIG. 9 is a table listing the segment features used in an example learning task.

FIG. 10 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with specific embodiments, it will be understood that it is not intended to limit the invention to these embodiments. On the contrary, the invention is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Extracting structured records from semi-structured pages can allow one to obtain a richer understanding of content and effectively address users' information needs. In general, records have a similar schema or set of attributes within a particular semantic category or domain, e.g., store information, events, product information. The terms domain and category are used herein interchangeably to refer to a semantic category and is not to be confused with a website domain. Extraction of attributes from these records, e.g., web page fragments, typically involves representing such fragments as sequences of text or HTML (HyperText Markup Language) tokens (e.g., words). These sequences of tokens can then be segmented, and each segment can be assigned a label corresponding to one of the record-attributes (e.g., name, address, and phone number, in the case of store-information), which can be addressed using a variety of learning techniques.

This extraction process is quite challenging because records can exhibit a wide amount of variability in the ordering and presentation of attributes across web pages, even within a single domain. For example, the broader category-specific features (e.g., parts of speech) are often not sufficiently predictive. However, for records within a single web page or web site, different instances of a particular attribute tend to share similar local properties, such as HTML/XPath structure and visual placement, and such local properties can be used to improve the extraction quality.

In general, embodiments of a transductive approach for effectively combining the predictive power of both the category-specific semantic features as well as site-specific structural features are described herein. A high precision category-specific model or labeler, with possibly poor recall, is initially applied to each candidate sequence (or annotatable content in a web page) to obtain partial, but high confidence labels, which can then be used to learn a model over both the site-specific structural features as well as the category-specific semantic features. In one implementation, this approach can generally be based on optimizing the marginal likelihood over the partially labeled text sequences.

Such a transductive approach enables one to perform high quality category-specific record extraction over multiple web-sites with minimal editorial input. This result can be especially useful for the numerous small websites that are not amenable for site-specific editorial annotation, for example, as required by other annotation techniques, such as wrapper induction based approaches.

The extracted record information can be used for any suitable application. For example, extracted structured information can be used to build search repositories, such as professional (e.g., conference, journals, etc.) or personal (e.g., blogs) publication pages, which can be searched by on-line communities, such as DBLife, MLLife, NetworksLife, etc. Other search repositories may include restaurant information, which is searchable by menu, cuisine, price, time, location, reviews, etc., or product information, which is searchable by price, product specifications, reviews, store, region, etc. Similar applications may be directed towards hotels, schools, florists, and other local businesses or services.

Although certain embodiments are described herein in relation to textual attribute-values of records, it should be apparent that an extraction system may also be provided for other types of attributes, such as links to audiovisual objects (e.g., photographs, music or video clips). Even though certain embodiments are described herein in relation to a record-list extraction system, it should also be noted that embodiments of the invention are contemplated in which the presentation of the records in the underlying web page is not necessarily contiguous, and the record boundaries are obtained independent of a list extraction approach with only the attribute extraction following the proposed transductive mechanism. In some embodiments, the extracted records may be used independently of the web page. In alternative embodiments, presentation of the web page, which is being analyzed for information extraction, may be adjusted or altered based on the extracted information.

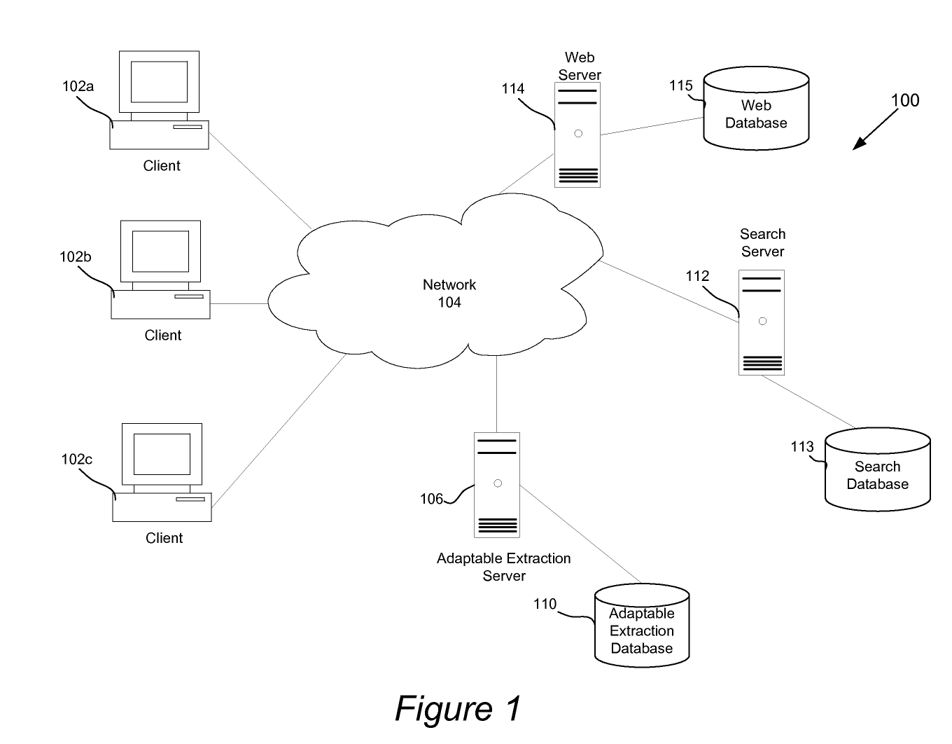

Prior to describing detailed mechanisms for adaptively extracting information of interest, a high level computer network environment will first be briefly described to provide an example context for practicing techniques of the present invention. FIG. 1 illustrates an example network segment 100 in which the present invention may be implemented in accordance with one embodiment of the present invention. As shown, a plurality of clients 102 may access a search application, for example, on search server 112 via network 104 and/or access a web service, for example, on web server 114. The network may take any suitable form, such as a wide area network or Internet and/or one or more local area networks (LAN's). The network 104 may include any suitable number and type of devices, e.g., routers and switches, for forwarding search or web object requests from each client to the search or web application and forwarding search or web results back to the requesting clients or for forwarding data between various servers.

Embodiments of the present invention may also be practiced in a wide variety of network environments (represented by network 104) including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The search server 112 may implement a search application. A search application generally allows a user (human or automated entity) to search for web objects (e.g., web documents, videos, images, etc.) that are accessible via network 104 and related to one or more search terms. In one search application, search terms may be entered by a user in any manner. For example, the search application may present a web page having any input mechanism to the client (e.g., on the client's device) so the client can enter a query having one or more search term(s). In a specific implementation, the search application presents a text input box into which a user may type any number of search terms.

Embodiments of the present invention may be employed with respect to web pages obtained from web server applications or generated from any search application, such as general search applications that include Yahoo! Search, Google, Altavista, Ask Jeeves, etc or specific search applications that include Yelp (e.g., a product and services search engine), Amazon (e.g., a product search engine), etc. The search applications may be implemented on any number of servers although only a single search server 112 is illustrated for clarity and simplification of the description.

When a search is initiated to a search server 112, such server then obtains a plurality of web objects that relate to the query input. In a search application, these web objects can be found via any number of servers (e.g., web server 114) and usually enter the search server 112 via a crawling and indexing pipeline possibly performed by a different set of computers (not shown).

The search server 112 (or servers) may have access to one or more search database(s) 114 into which search information is retained. For example, each time a user initiates a search query with one or more search terms and/or performs a search based on such search query, information regarding such search may be retained in the search database(s) 114. Likewise, each web server 114 may have access to one or more web database(s) 115 into which web page information is retained.

Embodiments of the present invention include an adaptable extraction system. The adaptable extraction system may be implemented within the search server 112 or on a separate server, such as illustrated adaptable extraction server 106. When web pages are provided (e.g., via search query or web crawling mechanisms), the adaptable extraction server 106 may be adapted to mine such provided web pages for structured information as described further herein.

Embodiments of the present invention will now be described in the context of extracting publication information, e.g., from conference type web pages, although techniques of the present invention may be practiced with respect to any suitable type of web pages and corresponding information of interest. Publications pages of authors typically comprise of list(s) of papers written by them in various journals and conferences. The attributes of interest in this domain for one example may include: Author, Title, Venue, and Affiliation. The term ‘label’ may also be used herein to denote a record attribute. The formatting of publication lists may vary across the pages, as a variety of delimiters, HTML tags, and styles may be used to indicate different publications. Some sample publication records belonging to different authors, that demonstrate the variance in formatting are listed as follows in Table 1:
William W. Cohen and Sunita Sarawagi. Exploiting dictionaries in named entity extraction: Combining semi-Markov extraction processes and data integration methods. In Proceedings of the Tenth ACM SIGKDD International Conference on Knowledge Discovery and Data Mining, Seattle, USA, 2004.
When Can We Trust Progress Estimators for SQL Queries? ACM SIGMOD 2005. (with Raghav Kaushik, Ravishankar Ramamurthy)
Robust identification of fuzzy duplicates. (with S. Chaudhuri and V. Ganti) Proceedings of the 21st International Conference on Data Engineering (ICDE), 2005.

### Table 1: Example Publication Records

A transductive, adaptable extraction system is able to correctly handle such variance in a fully-automatic manner. Domain knowledge for the publications domain may be provided in the form of lexicons of author names, conference names, frequently occurring n-grams (n=2, 3, or 4) in the paper titles, and names of a few affiliations. These lexicons may be far from complete and, consequently may only be used to bootstrap the extraction system. As more and more entities are extracted by the system, these lexicons can be enhanced by adding high precision instances of particular labels and values.

Implementing a transductive, adaptable approach across highly variable web page formats may present several challenges. For example, multiple models need to be learned for different web pages because the data presentation changes a lot across different publication pages. It would be beneficial to utilize joint segmentation models that emit the attributes, e.g., Title, Author, Affiliation, and Venue, together from a publications record. In some cases, such a model can be superior to models that emit the labels independently. However, training a joint segmentation model often requires fully-labeled training records (e.g., each token in the training record has a label). However, only partially-labeled records may be available due to the poor recall of the provided domain-specific labelers. Training joint models with partially-labeled records is not well understood. Even when segments are labeled, such labeling may not always be complete. For example, a Title labeler will mark a frequent bigram inside a title, and the bigram itself may not span the complete title. In this sense, the labeled segments are “open for expansion” on both sides. The final challenge is that human supervision or feedback is costly and consequently, cannot be provided for each page to “correct” the output from labelers.

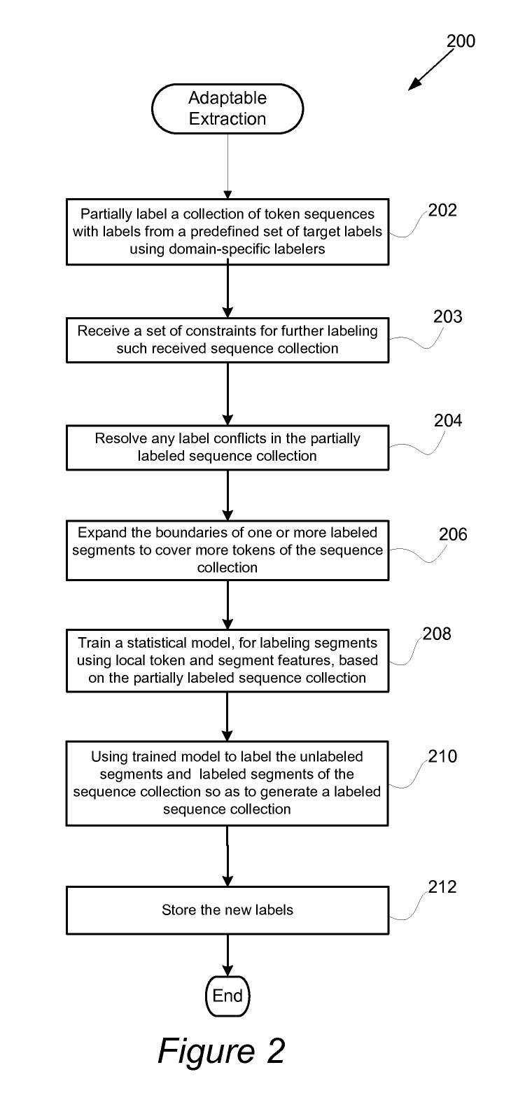

Embodiments of a transductive, adaptable extraction system are provided herein to address many of the above described challenges. FIG. 2 is a flow chart illustrating a procedure 200 for adaptively extracting information from a web page in accordance with a specific implementation of the present invention. Initially, a collection of token sequences is partially labeled with labels from a predefined set of target labels using domain-specific labelers in operation 202. A set of constraints for further labeling such received sequence collection may also be received or provided in operation 203.

A sequence collection may be partially labeled in any suitable manner. A collection of token sequences generally corresponds to a sequence of annotatable tokens, such as alphanumeric characters, words, sentences, or paragraphs or audiovisual images, videos, or audio files or links, etc. The token sequences of a sequence collection may correspond to entity-records that each comprises a set of attributes associated with an entity. For example, a store record may be composed of attributes such as the name, address, and phone number of a particular business store. These entity records may occur as web page fragments that are similarly positioned within a web page or a web site, e.g., they share a similar URL and/or XPath. An important special case is one that corresponds to record lists where the record fragments are contiguously placed and are immediate children of a DOM node in a page. Examples include pages containing lists of store locator results, shopping product details, or events from a calendar.

The partially labeled sequence collection may have been generated using any suitable annotation technique. For example, regular expressions, or lexicons may have been used to label specific words and phrases. These tools may be domain specific. For instance, a first lexicon may list specific organizations based on domain, such as listing universities and laboratories for science publication domain web sites, while a second lexicon may list specific store names for shopping domain web sites. In another example, a dictionary may list words as belonging to a specific label, such as first, middle or last names. Alternatively, frequent bi- or tri-grams that appear frequently in the titles of one or more compiled publication databases, such as the DBLP (digital bibliography and library project) website, may be assessed as forming part of a title.

In a specific implementation, the start and end of each record in a page or web site is identified, and one or more token sequences in such identified records have been initially labeled. Several techniques for identifying and annotating records on a web page (including the special case where the records are arranged contiguously as record lists) are further described in U.S. patent application Ser. No. 12/408,450, entitled “Apparatus and Methods for Concept-Centric Information Extraction”, filed 20 Mar. 2009 by Daniel Kifer et al., which application is herein incorporated by reference in its entirety for all purposes.

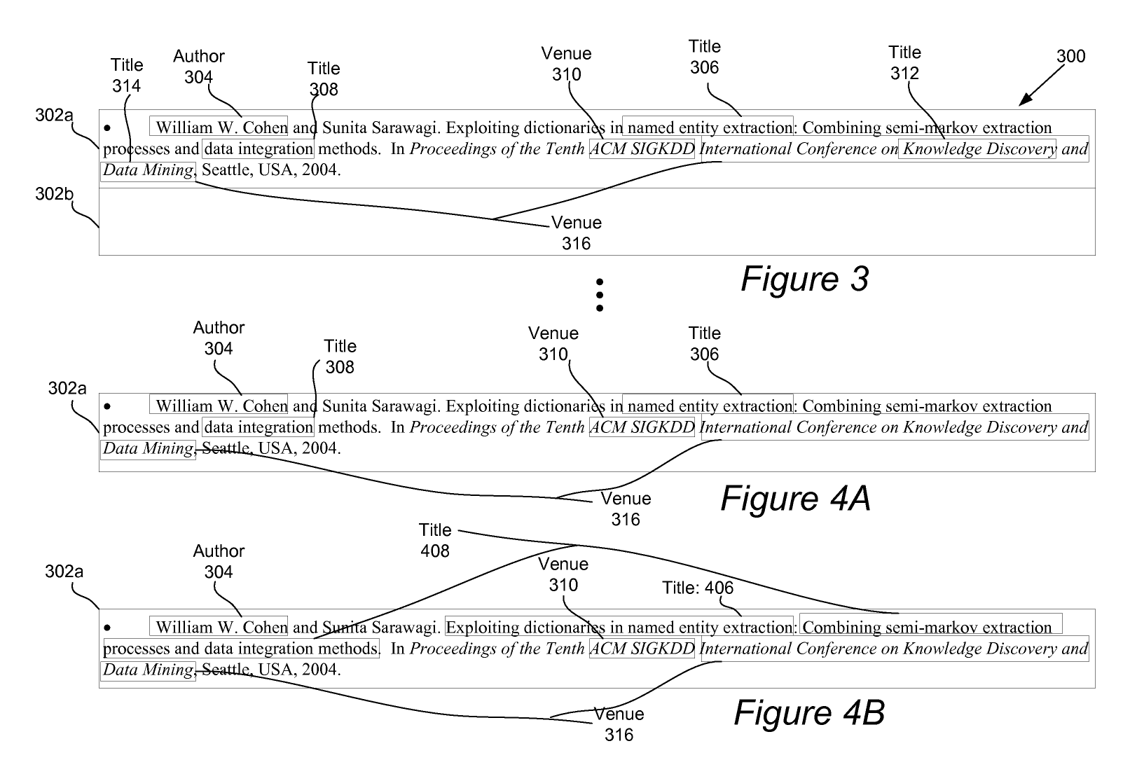

FIG. 3 is an example representation of a partially labeled sequence collection 300. As shown, the sequence collection 300 includes a plurality of publication records, such a first publication record 302a (with its contents being shown) and a second publication record 302b (with its contents not shown). Of course, the sequence collection 300 would typically include numerous publication records (not shown).

Details of the partial labels of the first publication record 302a are shown in FIG. 3. As shown, the sequence of tokens “William W. Cohen” 304 has an author label. The title label has been applied to token sequence “data integration” 308, “named entity extraction” 306, and “Knowledge Discovery” 312. The venue label has been applied to token sequence “ACM SIGKDD” 310 and “International Conference on Knowledge Discovery and Data Mining” 316.

Referring back to the illustrated process of FIG. 2, any label conflicts in the partially labeled sequence collection may be resolved in operation 204. This conflict resolution operation may include the use of predefined constraints provided by the user. The boundaries of one or more labeled segments may also be expanded to cover more tokens of the sequence collection in operation 206. As in the case of conflict resolution, the expansion policy might be based on the constraints provided by a user.

After conflict resolution and expansion operations are performed on the partially labeled sequence collection, a statistical model (for labeling segments using local token and segment features) may then be trained based on the partially labeled sequence collection in operation 208. Unlabelled and labeled segments in the sequence collection can then be labeled using the trained model so as to generate a labeled sequence collection in operation 210. The last step involving annotation using the statistical model may utilize the received predefined set of constraints.

The received set of predefined constraints may be represented in terms of functions that can be evaluated on the sequence of labels assigned to the tokens in each sequence as well as the properties of the tokens or labeled segments. For example, a constraint may specify the required order of two or more of the target labels in a record. For example, a constraint can specify that the Author label always precedes the ConferenceName label in a publication record. A constraint may also specify conditions on the counts of one or more labels in a record. For instance, a constraint may specify that there should be at most five Author labeled segments in a publications record. Another instance of constraint can involve specifying that one or more contiguous segments are assigned a particular set of labels when the corresponding segments satisfy certain properties. In one example, an acronym followed by a numeric should be labeled as ConferenceName and Year, respectively. As mentioned earlier, such complex constraints can be readily incorporated into the initial pre-processing (e.g., conflict resolution and labeled segment expansion), as well as the inference steps after training. Depending on the chosen statistical model, a special case of constraints (e.g., first order Markovian constraints for a sequential model) may also be incorporated into the training process. In some embodiments, these constraints may be “hard” so that a particular labeling either conforms to the constraint or not, whereas in some other embodiments, the constraints may be “soft” and result in a cost function that indicates the extent to which a particular labeling of a token sequence violates the constraint (e.g., penalty of 0 for Author count <4; 1 for Author count in range of [5-10]; and 10 for Author count >10 in a publication record).

In some embodiments, training can only support a limited family of constraints, viz. first order Markovian constraints. In one implementation, zero-order Markovian constraints (e.g., constraints on the label of a given sequence of tokens) are used. In first order constraints, the label of a token sequence is constrained and conditional to the label of the preceding token sequence, e.g. Title segment should always be followed by punctuation, or Author should always be followed by Affiliation or punctuation. However during inference (e.g., labeling unlabeled segments), more complex constraints (e.g. there should be at most five Author segments in a publications record, or at least two Affiliation segments should have the same textual content) can be supported. Note that the run-time complexity of inference can become exponential in the number of labels for arbitrarily hard constraints.

The labeled sequence collection may then be stored in one or more databases in operation 212. The stored labeled sequence collection information may later be utilized for any suitable purpose. For instance, users may perform specific database queries to retrieve and display particular information that was extracted from multiple sources of web content. Such retrieved information may be used for research and/or marketing purposes. For example, the retrieved information may be compiled and displayed on a particular web page to attract more users and advertisers to such web page. The new labeled token sequences may also be used to enhance existing domain knowledge, such as for example lexicons or regular expressions, which can be later employed to partially label other sequence collections.

In sum, the partially annotated token sequence may undergo post processing that includes conflict resolution and label expansion. For example, the partially labeled sequence collection of FIG. 3 includes several conflicting labels in the record 302a, as well as labels that could be expanded. Specifically, the token sequence “Knowledge Discovery” 312 has a Title label, as well as being included in the token sequence “International Conference on Knowledge Discovery and Data Mining” 316 that has a venue label. The title label for sequence 308 and sequence 306 can be expanded. FIG. 4A illustrates the record 302a after conflict resolution, while FIG. 4B illustrates such record after label expansion.

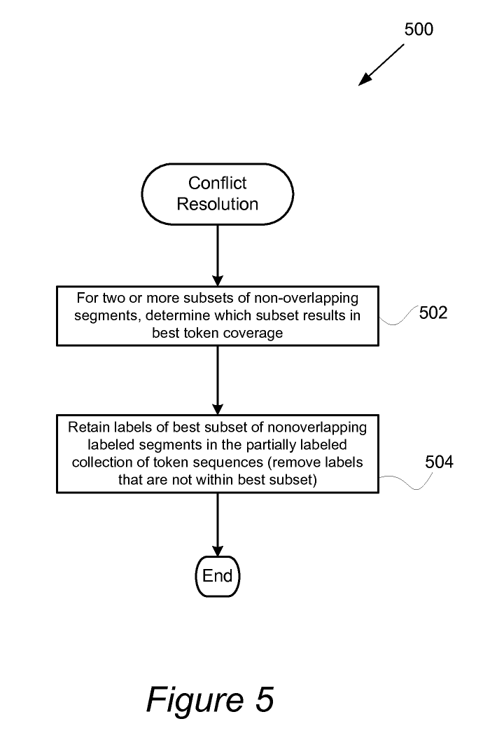

Any suitable technique may then be used to resolve conflicts in the partially annotated sequence collection. FIG. 5 is a flowchart illustrating a procedure 500 for conflict resolution in accordance with a specific implementation of the present invention. For two or more subsets of non-overlapping segments (e.g., contiguous subsequences of tokens in a token sequence in the current context), it may initially be determined which subset results in the best token coverage in operation 502.

In the example partially labeled sequence collection 302a of FIG. 3, the segment “Knowledge Discovery” corresponds to both a title label 312 and a venue label 316. If the selected set of non-overlapping labeled segments includes the title label 312 and excludes the venue label 316, twelve words (including initial “W.”) are covered. In contrast, if the selected set of non-overlapping labeled segments includes the venue label 316 and excludes the title label 312, eighteen words are covered. Accordingly, the subset that includes the venue label 316 (and not the title label 312) is assessed as having the best token coverage.

When the coverage is deemed to be acceptable for a particular subset of non-overlapping labeled segments, the labels for this best subset of non-overlapping labeled segments may then be retained in the partially labeled collection of token sequences in operation 504. As a result, the labels that are not within the best subset (e.g., the title label 312) are removed from the partially labeled sequence collection. FIG. 4A shows the author label 304, title label 308, venue label 310, title label 306, and venue label 316 as being retained in the partially labeled sequence collection.

In certain embodiments, all possible subsets may be assessed until the maximum coverage is found. However, when large sequence collections are assessed for conflict resolution, the number of possible label subsets may become significant and require significant computation resources. Accordingly, in other embodiments only a certain number of the possible subsets are chosen to be assessed to determine a label subset that provides “good enough” coverage. Example techniques for optimizing coverage may include use of independent sets in interval graph, greedy algorithms, local search algorithms, etc. In certain embodiments, one might also try to ensure that the labeling does not violate the predefined constraints in addition to maximizing the token coverage (e.g., number of labeled tokens),

A more formalized implementation will now be described. Since each labeled segment is an interval of the kind [start; end] with “start” and “end” denoting the indices into the entire toke sequence, this problem can be naturally modeled with interval graphs. An interval graph G can be formed to include one node per labeled segment, and an edge between two corresponding nodes if the two corresponding intervals overlap. The weight of a node can correspond to the number of tokens covered by its interval. A maximum weight independent set may then be found in the interval graph G.

A maximum weight independent set can be computed in polynomial time for interval graphs by using dynamic programming. Let the intervals be sorted in descending order of their right end points. The interval I at the top of this sorted list can then be considered and the best independent set that contains I is computed, as well as the best independent set without I. For the former case, all intervals that overlap with I can then be removed. Both cases can be computed recursively. The better of the two independent sets can then be defined as the new labeled set of labeled sequences. In practice, starting the computation from the top of the sorted list will lead to a runtime exponential in the number of intervals. But since this is the same as doing dynamic programming, the computation can be started from the bottom of the sorted list. The best independent set can then be computed from the first k intervals, and then for k+1. The computation for finding the best independent set from k+1 intervals will re-use the computation for independent set from k intervals. This will lead to a polynomial runtime.

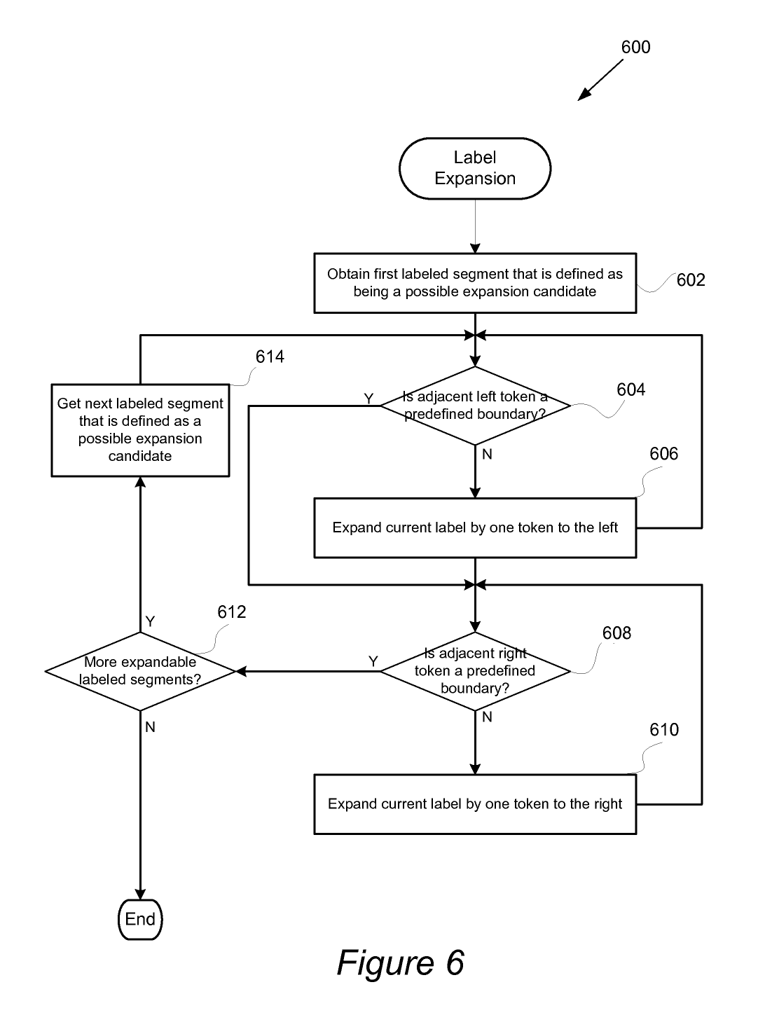

Any suitable technique for expanding labels may also be utilized with respect to the partially labeled sequence collection. FIG. 6 is a flowchart illustrating a label expansion procedure 600 in accordance with one embodiment of the present invention. Initially, a first labeled segment that is defined as being a possible expansion candidate is obtained in operation 602. Expansion candidates may be determined by the label associated with the segment, as well as the properties of the segment itself as specified in the predefined constraints (e.g., a constraint may specify expansion of fragments within DOM text nodes labeled as titles while not expanding other label types, such as people names or other types of DOM nodes)

Each side of the current labeled segment may be expanded. For example, it may first be determined whether an adjacent left token is a predefined boundary in operation 604. That is, it is determined whether the left side of the current label sequence already borders a predefined boundary. In one implementation, a predefined boundary may conservatively correspond to a delimiter token, an HTML boundary token, another labeled token, etc. If the adjacent left token is not a predefined boundary, the current label is then expanded by one token to the left in operation 606. Otherwise this operation 606 is skipped. Expansion of the current label to the left continues until a predefined boundary is found.

After the left has been expanded as much as possible, it may then be determined whether the adjacent right token is a predefined boundary in operation 608. If there is no predefined boundary on the right of the current label, the current label is then expanded by one token to the right in operation 610. Otherwise, it may then be determined whether there are more expandable segments in operation 612. If there are no more expandable label segments, the procedure 600 ends. Otherwise, a next labeled token segment that is defined as a possible expansion candidate is then obtained in operation 614 and the procedure is repeated for such next labeled segment.

In the example of FIG. 4A, the title label 308 for segment “data integration” is expanded into title label 408 (FIG. 4B) to cover the larger segment “Combining semi-Markov extraction processes and data integration methods.” Likewise, the title label 306 for the segment “named entity extraction” of FIG. 4A is expanded into title label 406 (FIG. 4B) to cover the segment “Exploiting dictionaries in named entity extraction”.

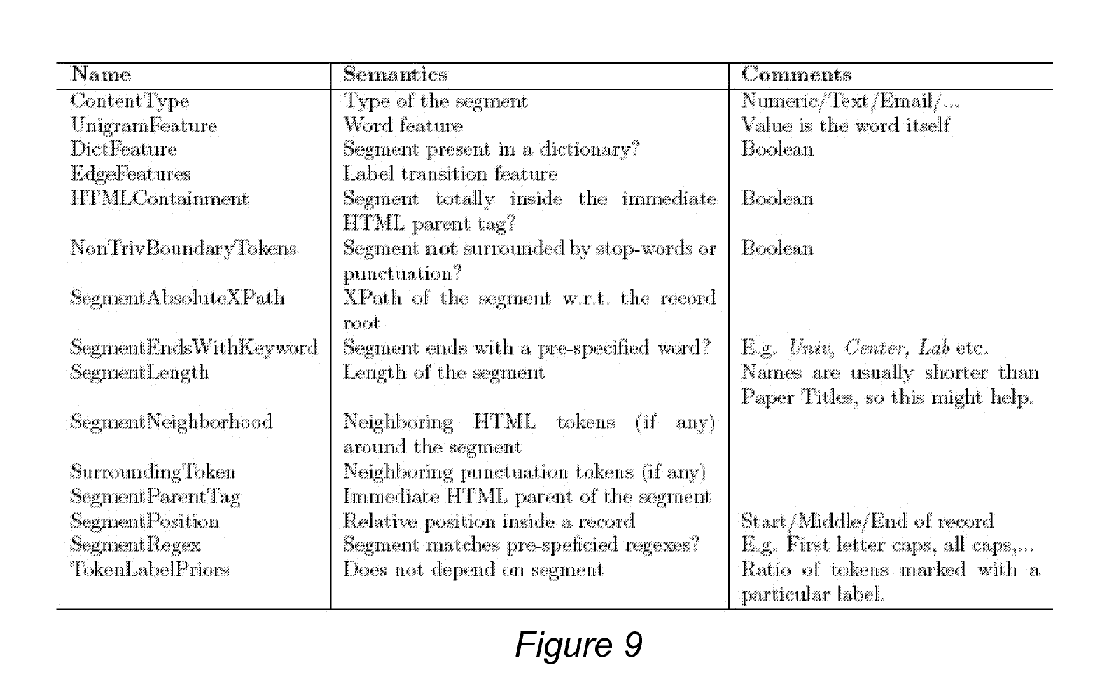

After a sequence collection is partially labeled and conflict resolution and label expansion are performed, this partially labeled sequence collection can then be used to train a model to label the token sequence. In one implementation, a semi-Markov conditional random field (semi-CRF) model that simultaneously segments a record into token sequences (or segments) and labels such segments may be used. If x denotes a record and y denotes a segmentation and labeling, then the suitability of y for x under a semi-CRF model can be given by Equation 1A:

$$P ( y \vert x , w ) = \frac{exp {w}^{T} F ( y , x )}{{Z}_{x}} \qquad ( 1 A )$$

where F(y; x) is a joint feature vector of the record and the candidate segmentation y, w is the weight vector, which can be learned during training, and Z, is a normalization factor. Example features are described below with reference to FIG. 9.

Instead of a semi-Markov CRF model, other types of models may alternatively be implemented with respect to the techniques of the present invention. Example alternative models may include a sequential model, such as a structural support vector machine. An alternative model is further described in the publication: I. Tsochantaridis, T. Joachims, T. Hofmann, and Y. Altun, Large Margin Methods for Structured and Interdependent Output Variables, Journal of Machine Learning Research (JMLR), 6(September):1453-1484, 2005, which paper is incorporated herein by reference in its entirety.

Referring back to the illustrated example, conventional training procedures for semi-CRF's expect full segmentations. However, since the above described approach only outputs partial segmentations, a different training objective can be used, than the conventional semi-CRF model objective. In one implementation, the marginal probability of a partially-labeled record is maximized with respect to the model parameter w. If x, and y, (i=1, 2, 3 . . . ) are the training records along with their partial segmentations, respectively, the marginal likelihood maximization problem may be given by:

$${max}_{w} {\sum }_{i} log {\sum }_{y : y \sim {y}_{i}} P ( y \vert {x}_{i} , w ) - C {‖ w ‖}^{2} \qquad ( 1 )$$

where x denotes a token sequence, y denotes a segmentation and labeling, P denotes the suitability of y for x under a semi-CRF model (as described further below), w denotes a weight vector which can be learned during training, and C denotes the standard regularization term used to avoid over fitting of the data, and where y˜yᵢ means that the full segmentation y does not violate the partial segmentation yᵢ. A full segmentation y does not violate the partial segmentation y, if every labeled segment in y, is labeled with the same label in y. The regularization term C can be set by an offline validation process where various values of C are tried on a development dataset and the best one retained. A value of 50 or 500 is fairly standard.

The gradient of this marginal likelihood can be given by:

$$∇ = {\sum }_{i} {E}_{y \sim {y}_{i}} [ F ( y , {x}_{i} ) ] - {E}_{all y} [ F ( y , {x}_{i} ) ] \qquad ( 2 )$$

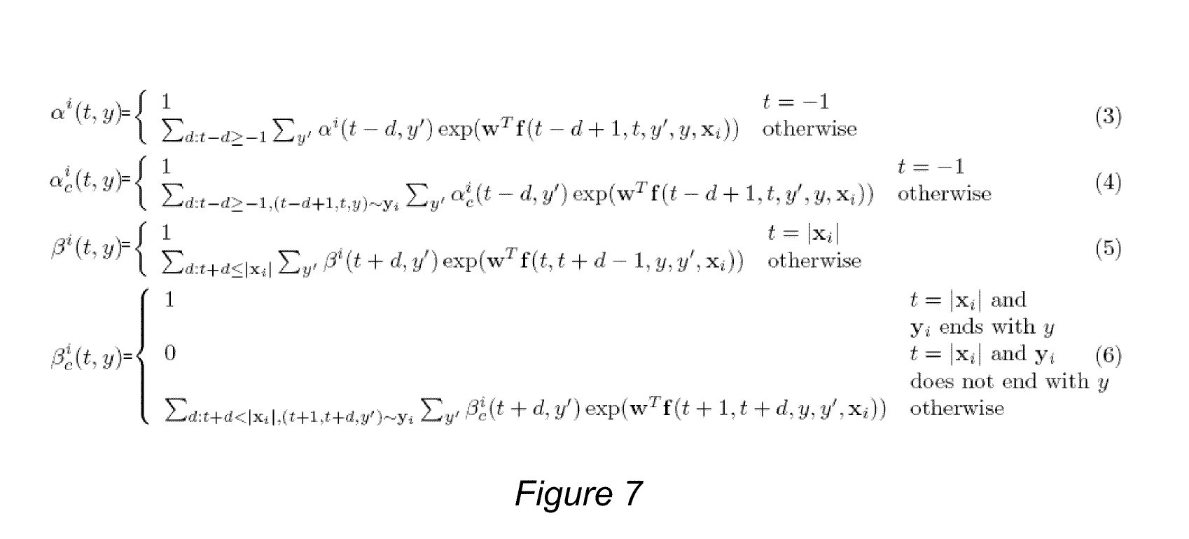

It is extremely expensive to compute these terms directly as they require a summation over an exponential number of labelings (y). An alternate strategy is to compute these terms using auxiliary parameters α and β. The αⁱ and βⁱ vectors for an example {xᵢ, yᵢ} are defined in the publication: Sunita Sarawagi and William W. Cohen. Semi-Markov Conditional Random Fields for Information Extraction, In NIPS 2004, which article is incorporated herein by reference in its entirety for all purposes. These αⁱ and βⁱ vectors may be extended to include constrained versions of these vectors, denoted by α_{c}ⁱ and β_{c}ⁱ. A set of four vectors may be given by Equations (3)˜(6) as shown in FIG. 7.

As shown in Equations 4 and 6 in FIG. 7, a clause of the form “(t, u, y)˜yᵢ” means that the segment from position t to u (inclusive) labeled y should not violate the corresponding partial segmentation yᵢ. The vector f is the local version of F, and f is only applied to one segment, as opposed to the entire segmentation. The interpretation of the new vectors is as follows: α_{c}ⁱ(t,y) is the unnormalized marginal probability of a segment ending at position t with label y given that the segmentation till position t (inclusive) does not violate the partial segmentation yᵢ. Similarly β_{c}ⁱ (t; y) is the marginal probability of a segment starting at position t+1 given that the previous segment ended at position t with label y, and also given that the segmentation starting from position t+1 (inclusive) does not violate the partial segmentation yᵢ.

These four vectors can now be used to compute the unconstrained and constrained versions of the normalization constants used in semi-Markov CRFs. These constants are denoted by Z(xᵢ,w) and Z_{c}(xᵢ,w), respectively, and can be computed as:

$$\begin{matrix}Z ( {x}_{i} , w ) = {\sum }_{y} {α}^{i} ( \vert {x}_{i} \vert , y ) & ( 7 ) \\ {Z}_{c} ( {x}_{i} , w ) = {\sum }_{y} {α}_{c}^{i} ( \vert {x}_{i} \vert , y ) & ( 8 )\end{matrix}$$

These normalization constants denote the total unnormalized probability mass of the unconstrained and unconstrained segmentations respectively. Together, these six quantities can now be used to efficiently compute the training objective and the gradient terms in Equations 1 and 2.

$$\begin{matrix}{E}_{all y} [ F ( {x}_{i} , w ) ] = \frac{1}{Z ( {x}_{i} , w )} {\sum }_{t , u , y} ( \begin{matrix}{\sum }_{{y}^{′}} {α}_{i} ( t - 1 , {y}^{′} ) \cdot \\ f ( t , u , {y}^{′} , y , {x}_{i} )\end{matrix} ) \cdot {β}^{i} ( u , y ) & ( 9 ) \\ {E}_{y \sim {y}_{i}} [ F ( {x}_{i} , w ) ] = \frac{1}{{Z}_{c} ( {x}_{i} , w )} {\sum }_{t , u , y} ( \begin{matrix}{\sum }_{{y}^{′}} {α}_{c}^{i} ( t - 1 , {y}^{′} ) \cdot \\ f ( t , u , {y}^{′} , y , {x}_{i} )\end{matrix} ) \cdot {β}_{c}^{i} ( u , y ) & ( 10 )\end{matrix}$$

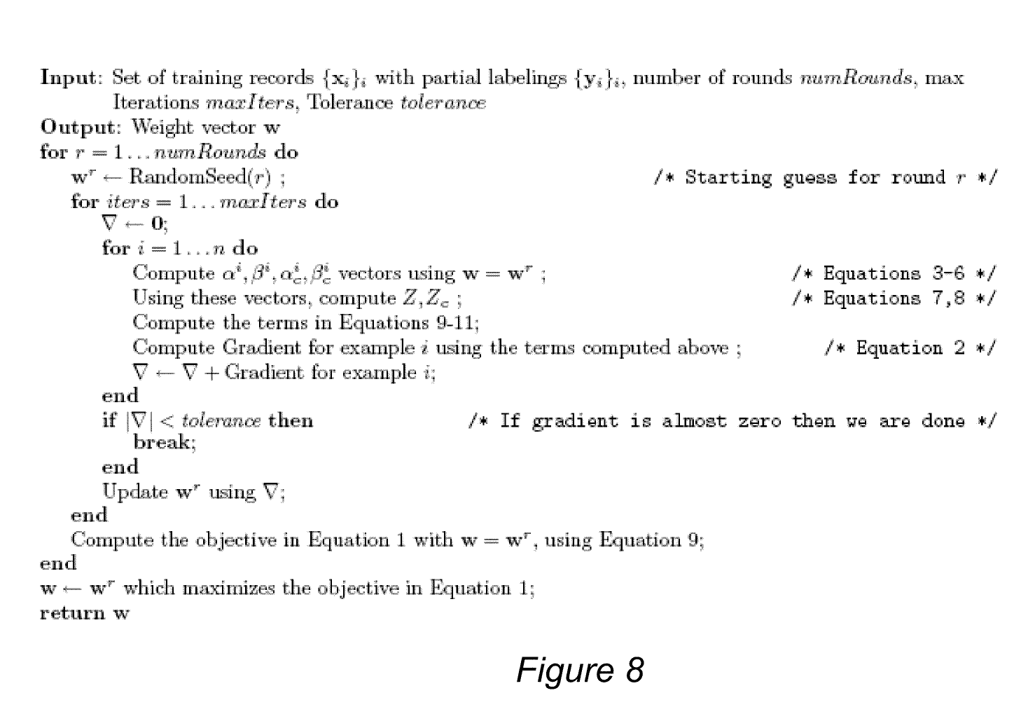

Finally, to optimize Equation 1, the Algorithm 1 as illustrated in FIG. 8 can be used. Algorithm 1 is an iterative algorithm that tries to make the gradient equal to zero, starting from an initial guess for w. Since the objective is not concave in w, setting the gradient to zero will give a local optima and not a global optima. Accordingly, multiple trials are performed, where in each trial a different starting guess is used for w. Finally, the w which leads to the best objective is returned as output.

The updating step for w1 varies with the implementation. One example updating method is the limited-memory quasi Newton method or LBFGS, as used in the above referenced Sunita Sarawagi et al. publication.

Any suitable feature vectors may be utilized for training an extraction model and depends on the particular domain and application. A feature set can be selected so that a significant subset of such feature set will be relevant for a domain, and at least a few will be good enough for a single page (or list) inside a domain. For instance, in publication records of the same type as the first example of Table 1 above, there are no segments inside parentheses, so that is not a relevant feature.

It is noted that features of segments can be much more expressive and natural than features over individual tokens. This difference is the chief reason behind using a semi-CRF model, rather than the conventional CRF model. This choice can have an associated cost, as straight forward inference procedure in semi-CRFs is cubic in the record length, as compared to linear in simpler CRFs. However, this cost can be brought down to linear by using an alternate feature representation, as discussed in the publication: Sunita Sarawagi, Efficient inference on sequence segmentation models, In Proceedings of the 23^{rd} International Conference on Machine Learning (ICML), Pittsburgh, Pa., USA, 2006, which publication is incorporated herein by reference in its entirety.

The segment features used in an example task are listed the Table of FIG. 9. These features apply to a single segment. Feature “EdgeFeature” also depends on the label of the previous segment.

Certain embodiments of the present invention can allow unsupervised information extraction. Additionally, simpler classifiers can be used to initially and accurately label parts of a sequence collection, which can then be used to train a feature-rich semi-Markov CRF model. Certain embodiments enable one to perform high quality category-specific record extraction over multiple web-sites (unlike web site-specific extraction using wrapper-induction based methods) with minimal editorial input. This approach can be especially useful for the numerous small websites (e.g., long tail) that are not amenable for site-specific editorial annotation required for wrapper induction based approaches.

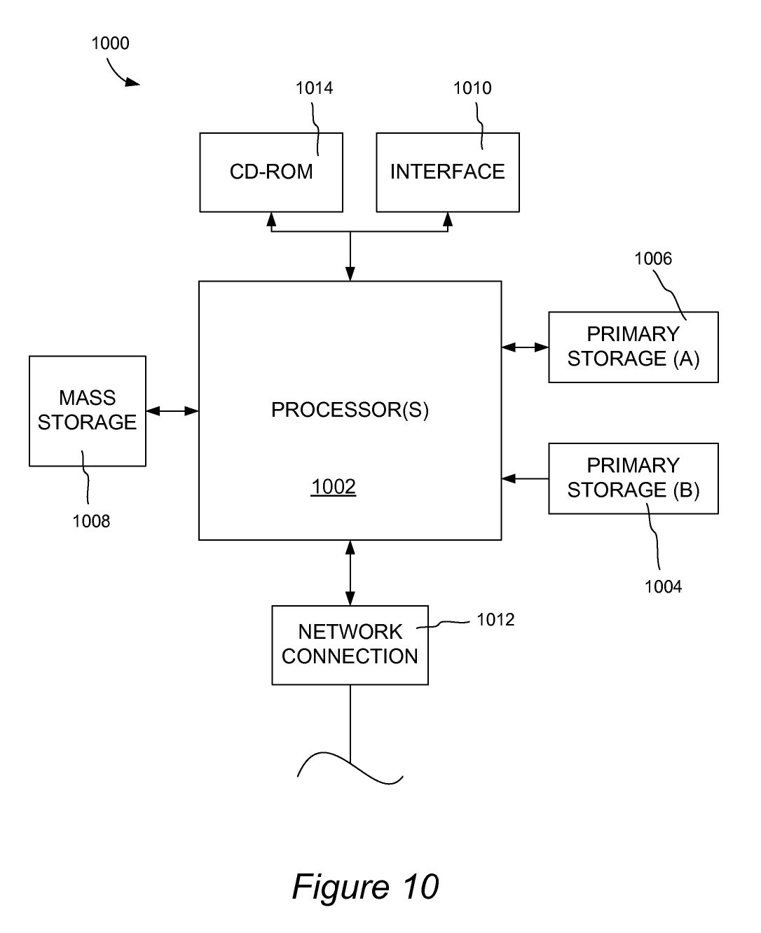

The techniques and system of the present invention may be implemented in any suitable hardware. FIG. 10 illustrates a typical computer system that, when appropriately configured or designed, can serve as an adaptable extraction system. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). CPU 1002 may be of various types including microcontrollers and microprocessors such as programmable devices (e.g., CPLDs and FPGAs) and unprogrammable devices such as gate array ASICs or general-purpose microprocessors. As is well known in the art, primary storage 1004 acts to transfer data and instructions uni-directionally to the CPU and primary storage 1006 is used typically to transfer data and instructions in a bi-directional manner. Both of these primary storage devices may include any suitable computer-readable media such as those described herein. A mass storage device 1008 is also coupled bi-directionally to CPU 1002 and provides additional data storage capacity and may include any of the computer-readable media described herein. Mass storage device 1008 may be used to store programs, data and the like and is typically a secondary storage medium such as a hard disk. It will be appreciated that the information retained within the mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 is also coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to an external device such as a database or a computer or telecommunications network using an external connection as shown generally at 1012. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store sequence collections, partially labeled sequence collections, subsets of such collections, token coverage amounts, interval graphs, learning models and parameters, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of segmenting and labeling a collection of token sequences, comprising:
partially labeling a plurality of segments of one or more tokens in a token sequence collection with labels from a set of target labels using high precision domain-specific labelers so as to generate a partially labeled sequence collection having a plurality of labeled segments and a plurality of unlabeled segments;
resolving any label conflicts in the partially labeled sequence collection;
expanding one or more of the labeled segments of the partially labeled sequence collection so as to cover one or more additional tokens of the partially labeled sequence collection;
training a statistical model, for labeling segments using local token and segment features of the sequence collection, based on the partially labeled sequence collection, and then using such trained model to label the unlabeled segments and the labeled segments of the sequence collection so as to generate a labeled sequence collection; and
storing the labeled sequence collection as structured output records in a database.

2. The method as recited in claim 1, wherein the sequence collection includes entity records formed by similar fragments in a single web page or web site, the labeled segments correspond to record attributes, and the tokens are obtained by tokenizing a source HTML or text in the fragments.

3. The method as recited in claim 2, wherein the local token and segment features are chosen to be web site-specific or web page-specific properties.

4. The method as recited in claim 1, further comprising improving the domain-specific labelers using the labeled sequence collection.

5. The method as recited in claim 1, wherein resolving any label conflicts is accomplished by:
for a given set of labeled segments from the partially labeled sequence collection, choosing a non-overlapping subset of these labeled segments such that a maximum number of tokens are labeled while ensuring that a set of user specified constraints are not violated; and
retaining the chosen non-overlapping subset of labeled segments while removing labels of the other labeled segments that are not part of the chosen non-overlapping subset.

6. The method as recited in claim/, wherein expansion of the labeled segments is accomplished using user-specified boundary properties for various labels.

7. The method as recited in claim 1, wherein the statistical model is a joint sequential model that labels all tokens in a sequence together, rather than independently.

8. The method as recited in claim 1, wherein
training the statistical model is based on optimizing a marginal likelihood over the partially labeled sequence collection, and
inference of segmentation and labeling of token sequences is based on the learned statistical model and a set of user-specified constraints.

9. An apparatus comprising at least a processor and a memory, wherein the processor and/or memory are configured to perform the following operations:
partially labeling a plurality of segments of one or more tokens in a token sequence collection with labels from a set of target labels using high precision domain-specific labelers so as to generate a partially labeled sequence collection having a plurality of labeled segments and a plurality of unlabeled segments;
resolving any label conflicts in the partially labeled sequence collection;
expanding one or more of the labeled segments of the partially labeled sequence collection so as to cover one or more additional tokens of the partially labeled sequence collection;
training a statistical model, for labeling segments using local token and segment features of the sequence collection, based on the partially labeled sequence collection, and then using such trained model to label the unlabeled segments and the labeled segments of the sequence collection so as to generate a labeled sequence collection; and
storing the labeled sequence collection as structured output records in a database.

10. The apparatus as recited in claim 9, wherein the sequence collection includes entity records formed by similar fragments in a single web page or web site, the labeled segments correspond to record attributes, and the tokens are obtained by tokenizing a source HTML or text in the fragments.

11. The apparatus as recited in claim 10, wherein the local token and segment features are chosen to be web site-specific or web page-specific properties.

12. The apparatus as recited in claim 10, wherein the processor and/or memory are further configured to improve the domain-specific labelers using the labeled sequence collection.

13. The apparatus as recited in claim 9, wherein resolving any label conflicts is accomplished by:
for a given set of labeled segments from the partially labeled sequence collection, choosing a non-overlapping subset of these labeled segments such that a maximum number of tokens are labeled while ensuring that a set of user specified constraints are not violated; and
retaining the chosen non-overlapping subset of labeled segments while removing labels of the other labeled segments that are not part of the chosen non-overlapping subset.

14. The apparatus as recited in claim 9, wherein expansion of the labeled segments is accomplished using user-specified boundary properties for various labels.

15. The apparatus as recited in claim 9, wherein the statistical model is a joint sequential model that labels all tokens in a sequence together, rather than independently.

16. The apparatus as recited in claim 15, wherein the partially labeled sequence collection specifies a start and end of each record in the record list, and one or more token sequences in such identified records have been initially labeled.

17. At least one computer readable storage medium having computer program instructions stored thereon that are arranged to perform the following operations:
partially labeling a plurality of segments of one or more tokens in a token sequence collection with labels from a set of target labels using high precision domain-specific labelers so as to generate a partially labeled sequence collection having a plurality of labeled segments and a plurality of unlabeled segments;
resolving any label conflicts in the partially labeled sequence collection;
expanding one or more of the labeled segments of the partially labeled sequence collection so as to cover one or more additional tokens of the partially labeled sequence collection;
training a statistical model, for labeling segments using local token and segment features of the sequence collection, based on the partially labeled sequence collection, and then using such trained model to label the unlabeled segments and the labeled segments of the sequence collection so as to generate a labeled sequence collection; and
storing the labeled sequence collection as structured output records in a database.

18. The least one computer readable storage medium as recited in claim 17, wherein the sequence collection includes entity records formed by similar fragments in a single web page or web site, the labeled segments correspond to record attributes, and the tokens are obtained by tokenizing a source HTML or text in the fragments.

19. The least one computer readable storage medium as recited in claim 18, wherein the local token and segment features are chosen to be web site-specific or web page-specific properties.

20. The least one computer readable storage medium as recited in claim 17, wherein the computer program instructions stored thereon are further arranged to improve the domain-specific labelers using the labeled sequence collection.

21. The least one computer readable storage medium as recited in claim 17, wherein resolving any label conflicts is accomplished by:
for a given set of labeled segments from the partially labeled sequence collection, choosing a non-overlapping subset of these labeled segments such that a maximum number of tokens are labeled while ensuring that a set of user specified constraints are not violated; and
retaining the chosen non-overlapping subset of labeled segments while removing labels of the other labeled segments that are not part of the chosen non-overlapping subset.

22. The least one computer readable storage medium as recited in claim 17, wherein expansion of the labeled segments is accomplished using user-specified boundary properties for various labels.

23. The least one computer readable storage medium as recited in claim 17, wherein the statistical model is a joint sequential model that labels all tokens in a sequence together, rather than independently.

24. The least one computer readable storage medium as recited in claim 22, wherein
training the statistical model is based on optimizing a marginal likelihood over the partially labeled sequence collection, and
inference of segmentation and labeling of token sequences is based on the learned statistical model and a set of user-specified constraints.
